(19) United States
(12) Patent Application Publication
(10) Pub. No.: US 2018/0097817 A1
(43) Pub. Date: Apr. 5, 2018

(54) GENERATING SHORT-TERM SIGNATURES FOR ACCESSING CLOUD STORAGE

(71) Applicant: Microsoft Technology Licensing, LLC, Redmond, WA (US)

(72) Inventors: Mohamed Abdelsalam Noureldien Aboubakr, Issaquah, WA (US); Samuel Lenz Banina, Bellevue, WA (US); Kyle Anthony Werner, Seattle, WA (US); David James Messner, Redmond, WA (US); Rajasekaran Rangarajan, Kirkland, WA (US); Andrew Michael Pennell, Kirkland, WA (US); Mariyan D. Fransazov, Kirkland, WA (US)

(21) Appl. No.: 15/283,152

(22) Filed: Sep. 30, 2016

(51) Int. Cl. H04L 29/06

(52) U.S. Cl. CPC H04L 63/108; H04L 63/20

(57) ABSTRACT

Securely storing assets in a cloud computer storage service. Preparation to store assets for a user may comprise determining a location to store the assets, generating a write access signature, and sending the determined location and the signature to the user. A request is received from the user to store the assets. Such a request includes the assets, the location, and the signature. In response to receiving the request, a determination is made regarding the write access signature whether the request should be honored. When the request is honored, the assets are stored in the determined location and the write access signature is invalidated. Upon subsequent user requests to access the assets, short-term read access signatures are generated and provided to the user. The assets are written once per generated write access signature and reads are to be performed close in time to when short-term read access signatures are requested.

### BACKGROUND

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments.

For example, cloud computer systems are increasingly popular. Such cloud computer systems may allow users to store large amounts of data in a remote location, regardless of the amount of local storage space to which the user has access. Oftentimes, users subscribe to such cloud storage computer systems by paying a monthly or annual fee for a certain pre-defined amount of storage. As such, many end users store a large amount of data in cloud storage systems, including data that may be valuable, personal and/or confidential. For these reasons, security of the data stored in cloud storage computer systems is vital. Accordingly, essentially all cloud computer systems have some form of security to protect stored information. For example, virtually all cloud storage computer systems employ some form of encryption of the data that is stored within a particular cloud storage system.

### BRIEF SUMMARY

At least some embodiments described herein relate to securely storing assets in a cloud computer storage service. For example, embodiments may include preparing to potentially store one or more assets for a user. The preparation comprises determining a location to store one or more assets for the user, generating a write access signature having a write access policy, and sending the determined location and the generated signature to the user. A request may then be received from the user to store the one or more assets. Such a request may include at least the one or more assets, the determined location, and the generated write access signature. In response to receiving the request to store the one or more assets, a determination is made from the write access policy of the write access signature whether the request should be honored.

When the request should be honored, the one or more assets are stored in the determined location and the generated write access signature is invalidated. Upon a subsequent user request to access the one or more assets, a short-term read access signature having an associated read-only policy is generated and provided to the user. As such, the one or more assets are written only once per generated write access signature. Additionally, reads are to be performed close in time to when short-term read access signatures are requested.

Generating short-term signatures in response to requests to access assets can greatly reduce the impact of storage key changes in response to both compromised storage keys and planned storage key changes. In particular, storage key changes in response to both compromised storage keys and planned storage key changes may be accomplished much more quickly because existing signatures are not manipulated. Furthermore, the short-term nature of signatures, as described herein, may protect against the malicious use of signatures by users who were previously authorized to access assets, but are no longer authorized. Finally, the use of time windows, as described herein, may improve efficiency in browsers/computer systems by utilizing browser-side/client-side caches to avoid any redundant network calls/downloads relating to unchanged assets.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates operation of the principles described herein.

FIG. 2 illustrates an example environment when an end user initially attempts to save an asset to a storage service.

FIG. 3 illustrates an environment after a user has initially saved assets within a storage service.

FIG. 4 illustrates a timeline associated with the validity of a signature.

FIG. 5 illustrates a flow chart of an example method for generating signatures to securely store assets in a cloud computer storage service.

### DETAILED DESCRIPTION

At least some embodiments described herein relate to securely storing assets in a cloud computer storage service. For example, embodiments may include preparing to potentially store one or more assets for a user. The preparation comprises determining a location to store one or more assets for the user, generating a write access signature having a write access policy, and sending the determined location and the generated signature to the user. A request may then be received from the user to store the one or more assets. Such a request may include at least the one or more assets, the determined location, and the generated write access signature. In response to receiving the request to store the one or more assets, a determination is made from the write access policy of the write access signature whether the request should be honored.

When the request should be honored, the one or more assets are stored in the determined location and the generated write access signature is invalidated. Upon a subsequent user request to access the one or more assets, a short-term read access signature having an associated read-only policy is generated and provided to the user. As such, the one or more assets are written only once per generated write access signature. Additionally, reads are to be performed close in time to when short-term read access signatures are requested.

Generating short-term signatures in response to requests to access assets can greatly reduce the impact of storage key changes in response to both compromised storage keys and planned storage key changes. In particular, storage key changes in response to both compromised storage keys and planned storage key changes may be accomplished much more quickly because existing signatures are not manipulated. Furthermore, the short-term nature of signatures, as described herein, may protect against the malicious use of signatures by users who were previously authorized to access assets, but are no longer authorized. Finally, the use of time windows, as described herein, may improve efficiency in browsers/computer systems by utilizing browser-side/client-side caches to avoid any redundant network calls/downloads relating to unchanged assets.

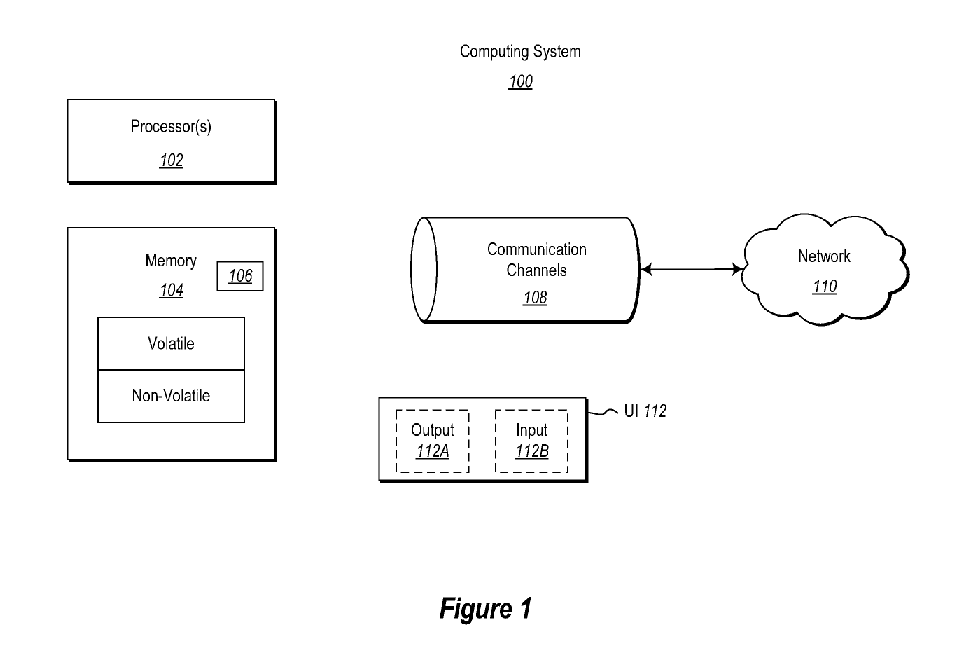

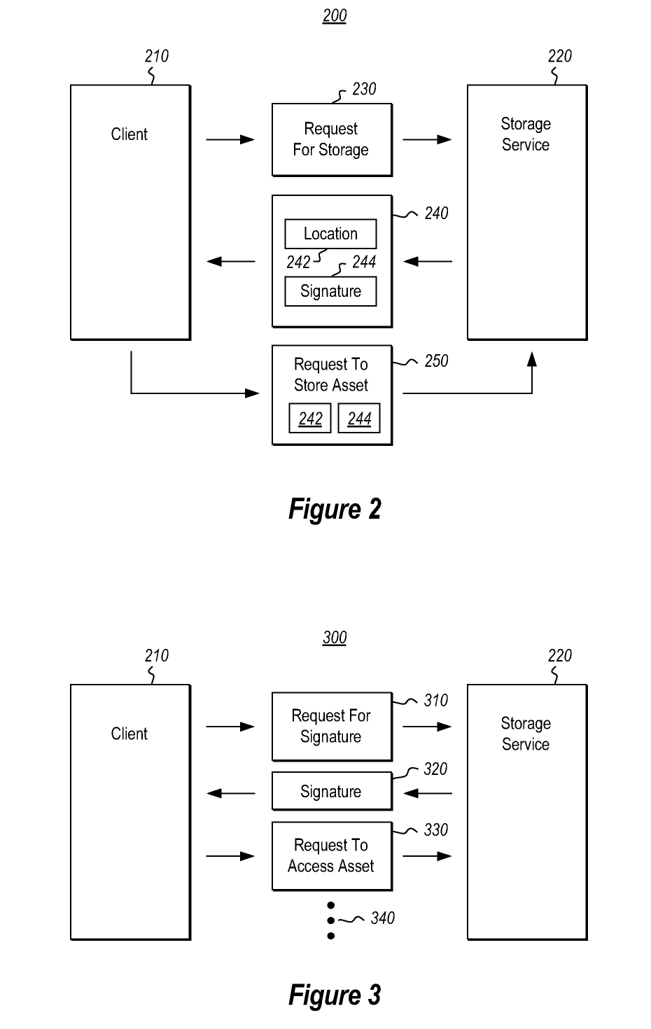

Some introductory discussion of a computing system will be described with respect to FIG. 1. Then generating signatures on-demand to securely store and access assets in a cloud computer service will be described with respect to FIGS. 2 through 5.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “control”, “signature generator”, “key generator” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

FIG. 2 illustrates a computer environment 200 when an end user initially attempts to save an asset to a storage service. FIG. 2 includes a computer system 210. Computer system 210 may comprise, for instance, the computer system 100 described herein and illustrated in FIG. 1. Computer system 210 may be any type of computer system used by an end user. For example, computer system 210 may comprise a desktop computer, laptop, smart phone, tablet, smart watch, and so forth. Additionally, computer system 210 may be running any applicable type of desktop or mobile operating system (OS), including MICROSOFT® WINDOWS®, APPLE® OS X®, APPLE IOS®, GOOGLE™ CHROME OS™, UBUNTU®, LINUX®, and so forth. FIG. 2 also includes storage service 220. Storage service 220 may also comprise the computer system 100 described herein and illustrated in FIG. 1. In some embodiments, storage service 220 may comprise a cloud computer service that allows a user to store data within storage of the cloud computer service. For instance, storage service 220 may comprise MICROSOFT AZURE®, AMAZON WEB SERVICES®, GOOGLE DRIVE™, APPLE ICLOUD®, DROPBOX®, and so forth.

As shown, FIG. 2 includes a request 230 for storage space in order to store an asset. Assets may include any information or data that can be stored in a cloud storage service. For instance, an asset may include a text file(s), audio file(s), video, images, applications, operating system images, and so forth. The principles described herein may be applied in any context that includes a computer system attempting to store or access data within a cloud computer service or other storage service. In an example that is used throughout, suppose an end user of computer system 210 is using a web version of MICROSOFT POWERAPPS™ (POWERAPPS). As such, the end user of computer system 210 may be creating and/or accessing apps within a web version of POWERAPPS. The end user may be the creator of such an app(s) or may have simply been authorized by the creator to access the app(s). For instance, in the ongoing example, each app may have a setting that allows for the creator to authorize other users to access the app.

Accordingly, creators/owners of assets that have been stored may authorize other non-owner/non-creator users to access the assets. Once authorized, those other users (i.e., non-owners or non-creators) may request to access stored assets and receive valid signatures to access the assets, as described more fully herein. Furthermore, such apps (e.g., created in POWERAPPS) may have numerous assets to be stored within a storage service 220 (e.g., MICROSOFT AZURE) to later be retrieved. For example, the user may have created an app and need somewhere to store the app. As such, the user may send a request 230 for storage space in order to store the created app and/or any assets included within the app (e.g., audio, video, text, and so forth) within storage service 220.

In response, the storage service 220 may send a response 240 that includes both a location 242 where the asset(s) are to be stored and a signature 244 that includes one or more permissions. Various permissions may be applicable, however, signature 244 included within response 240 may generally include a write permission that allows the user to store (or write) the assets in storage. In some embodiments, the response 240 may comprise a uniform resource identifier (URI), wherein the location 242 is a portion of the URI and the signature 244 is also a portion of the URI. In a more specific example, the signature portion of the URI may comprise a shared access signature (SAS), as used when storing assets or accessing stored assets in MICROSOFT AZURE.

Once the user has received the location and the signature, the user may send a request 250 to save the app and the app's associated assets using the provided location 242 and signature 244. In the continuing example, the user may have received response 240 in the form of a URI. As such, the user may send a request 250 to store/save the app/assets using the received URI, including the location URI portion (i.e., location 242) and signature URI portion (i.e., signature 244). As long as the location and signature provided by the user in request 250 are valid, the app (and/or the app's assets) will then be stored within the storage service 220.

Once the asset(s) are stored/saved, the write access signature 244 may expire. In some embodiments, the write access signature may be set to expire after a short, fixed period of time. For example, the short, fixed period of time may only be long enough for an expected volume of writes associated with the particular asset(s) being stored to occur. In other embodiments, the signature may simply be invalidated upon completing storage of the asset(s).

Expiration (or invalidation) of the signature 244 may occur for a number of reasons, including prevention of any malicious use of the signature, as well as to avoid having to continually store signatures for each end user. For instance, storing pre-generated signatures (e.g., URI's/links) in a database may result in a number of issues. As an example, such signatures would likely last for a long period of time, which could potentially lead to malicious use of the signature. In another example, any revocation/change in the storage key may result in regeneration of each signature stored using the new storage key, which may be extremely costly both in time and use of resources.

FIG. 3 illustrates a computer environment 300 after a user has initially saved assets within a storage service. As shown, FIG. 3 includes a request 310 for a signature in order to access assets that have already been saved. In the ongoing example, the user attempting to access the assets may not be the creator/owner of the assets, but may have been authorized to access the assets by the creator/owner, as described herein. Alternatively, the user may have created the app in POWERAPPS and have previously saved the app (or asset(s) of the application). The creator/owner may now be requesting a signature in order to access that app. However, as discussed herein, upon the initial storage/saving of an asset(s), the original signature may expire (or be invalidated). As such, when the user sends request 310 for a signature to access stored assets, the user may know the location 242 of the asset(s), but does not have a valid signature (or associated permission(s)) with which to access the assets.

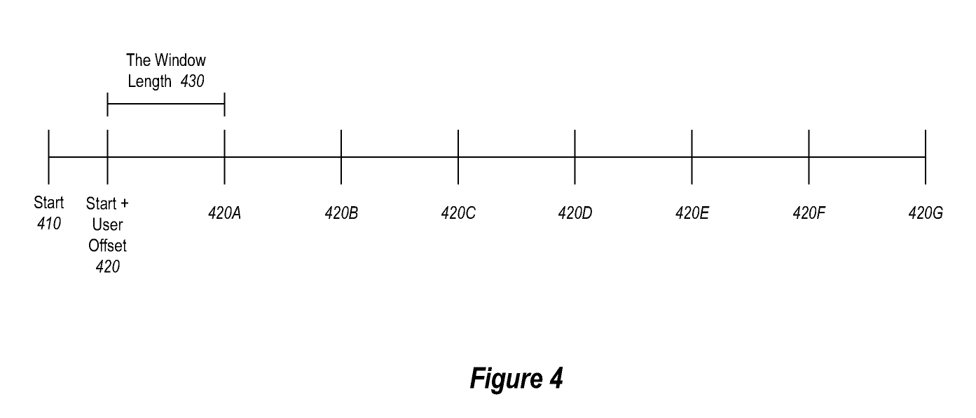

Upon receiving the request 310 from computer system 210, the storage service 220 may provide a short-term signature 320 having at least one associated permission. In some embodiments, short-term may comprise a different amount of time based on the type of asset being accessed, as described more fully with respect to FIG. 4. For instance, with an asset that is not likely to change often, the time period of validity may be longer. On the other hand, with an asset that is likely to change often, the time period of validity may be shorter. An example of an asset that is unlikely to change may be a video or audio file, while binaries associated with apps may be an example of assets that are more likely to change. The particular time periods assigned to a given signature may be any time period that is contextually appropriate. For instance, a time period may comprise as little as seconds, and as much as years.

In some embodiments, a short-term signature associated with a particular asset may be valid for the duration of the time period assigned to the signature, regardless of the number of times a user uses the signature to access the particular asset. For example, assume a user has already received a signature associated with an asset and has already accessed the asset once. The user may then continue to use that same signature to access the asset until the time period assigned to the signature has expired, at which point the user may be given a new signature upon a request to access the asset. Accordingly, once the user has received signature 320, the user may then send a request 330 to access the stored asset(s) using the received signature. While this process of requesting a signature, receiving a signature, and sending a request to access assets using the signature is only shown once, ellipses 340 demonstrates that such a process may occur any number of times.

With respect to the at least one associated permission, in some embodiments, read-only access is the only permission included. Read-only access may be the only included permission because once one of the assets (e.g., an application, assets within an application, and so forth) has been changed, any request to the storage service 220 regarding the changed asset comprises saving/storing the changed asset (as discussed with respect to FIG. 2 and request 230), rather than accessing an asset (as discussed with respect to FIG. 3 and request 310). Then, once the changed asset has been saved, any subsequent requests will comprise requests to access the asset.

As mentioned briefly, signature 320 may only be short-term (i.e., valid for only a short period of time) for a number of reasons. For instance, short-term read-only access may prevent access by users who were previously, but not currently, authorized by an owner of the assets to access the assets. In other words, in such situations, if the signature were long-term, a previously authorized user may still have possession of a valid location and signature from an earlier request to access the assets. Accordingly, such a user may have a valid location and a valid signature with which to access the assets, despite that user no longer being authorized to do so. As such, short-term signatures may prevent such occurrences.

Furthermore, a storage key, known only to the storage service, may be used by the storage service to create all valid signatures. In some such embodiments, signatures for all assets may be generated and stored in a database before any request is made. In such circumstances, when a request is made to access any stored asset(s), every signature is retrieved from the database and sent for accessing the requested asset(s) with minimum delay. While this is highly performant, if the storage key is compromised, every generated signature stored in the database has to be regenerated to avoid any unauthorized data access and/or data theft. Such regeneration can take multiple hours, or even days, as hundreds of thousands of assets, each having a distinct signature that needs to be regenerated, may be stored.

During this regeneration time, security breaches, unauthorized data accesses, data theft and data loss are all concerns. However, when generating only short-term signatures in response to requests to access assets (rather than before any request has been made), as discussed herein, the impact of a compromised/changed storage key is greatly reduced. Using such short-term signatures, both compromised and planned storage key changes can be accomplished more quickly because existing signatures are not manipulated. In such cases, any requests that occur after a storage key change result in new, valid short-term signatures.

FIG. 4 illustrates a timeline associated with the validity of a signature. As illustrated, in some embodiments, signatures may only be valid until the expiration time of a time window. FIG. 4 includes a timeline 400 having a starting position 410. The timeline 400 also includes an offset position 420 that comprises the starting position plus some user offset. Starting at offset position 420, time windows may then be created, during which a given signature is valid. Each given time window may comprise a fixed time period 430 in which a particular signature is valid. Accordingly, each time window is the same predetermined amount of time (e.g., each window comprises 24 hours, each time window comprises 15 minutes, and so forth).

An offset may be used in order to stagger the commencement and expiration of time windows for each given user (i.e., time windows would overlap rather than starting and stopping at the exact same time). Staggering the commencement and expiration of time windows may then prevent storage service 220 from having to generate and send new signatures to all users at roughly the exact same time. Such an offset may be calculated in any number of ways. For instance, each user may be assigned a specific identity. Then, the specific identity of each user may be hashed in order to create a distinct offset position that in turn creates distinct time windows (i.e., the commencement and expiration of a time window will be distinct) for each given user.

In some embodiments, a signature may be valid for only one time window. In other embodiments, a signature may be valid for two time windows. In yet other embodiments, time windows may be valid for three or more time windows. In cases where a signature is valid for only one time window, and a user receives a signature at some point within a time window (i.e., not during commencement or expiration of the time window), the signature may be valid for the rest of the time window in which it was received, as well as the next time window.

For example, assume that signatures are only valid for one-time window. Also, assume that a user received a signature at some point between position 420A and position 420B. Regardless of the exact position between position 420A and position 420B at which the user received the signature, the signature may be valid until position 420C (i.e., the signature expires at 420C). Alternatively, assuming both that signatures are only valid for one time window and that a user receives a signature in between two time windows, the signature may still expire at the end of the time window in which it was received. For instance, if a signature were received between position 420A and position 420B, the signature will expire at position 420B.

Using time windows as described herein may be especially relevant as it relates to the way in which certain assets are cached by a browser or client. For instance, an application/asset may include images, icons, videos, and so forth, that are cached by a browser or computer system of an end user when the end user accesses the application/asset from the storage service 220. For example, for each request that is made to access an asset, a network call may also be made, regardless of whether or not the asset being requested has changed. Furthermore, in some cases, a user (or a browser/computer system of the user) may poll assets frequently, which can result in many wasted calls and/or downloads regarding the same unchanged assets.

Accordingly, if a user were to receive a new URL (i.e., signature) for each of these requests/network calls, any browser-side/client-side cache that is capable of caching assets may be essentially invalidated, resulting in repeatedly downloading unchanged assets. Time windows may overcome these issues, as described herein.

For example, when an asset that is being requested matches an object in a browser/client cache, no network call is made to download the resource during the time window(s) in which the current signature is valid. In another example, when an asset that is being requested matches an object in a browser/client cache and a signature to access the asset has already been received for the current time window (i.e., the signature is still valid), a request to access the asset may still be made. However, the same signature may be received by the user in response to the request, resulting in a determination that the asset has already been cached/downloaded, and therefore is not to be downloaded again. In such a circumstance, when a subsequent signature is received during a time window in which a valid signature has already been received, and that subsequent signature is different than the previous signature received, it may be determined that the requested asset has changed. As such, the changed asset would be subsequently downloaded.

In a more specific example, assume that during a particular time window a user has already requested access to a video associated with an app, received a signature associated with the video, and has already downloaded the video. At that point, assume the user has made another request to access the video within the same particular time window. If the user then receives a different signature than the signature previously received during the same particular time window, a determination will be made that the asset has changed and may be downloaded. On the other hand, if the user then receives the same signature as the signature previously received during the same particular time window, a determination will be made that the asset is the same and does not need to be re-downloaded.

Accordingly, each time that a user makes a subsequent request to access an asset within a time window in which the user has already received a valid signature associated with the asset, the user may receive the exact same signature until either the time window has expired, the storage key has changed, or the asset has changed (e.g., the asset has been modified, removed, and so forth). In other words, when the storage service is asked to generate a signature during a time window having a particular starting point and ending point, if a second request to generate a signature is made during the same time window (i.e., both the starting point and ending point of the time window in which both requests were made is the same), the exact same signature will be generated (assuming the storage key is the same). For example, if a first request for a signature is made in the time window starting at 420A and ending at 420B, a second request during that same time window (i.e., starting at 420A and ending at 420B) will result in the same signature as the first request. Once it has been discovered that a cached asset has changed, the cache may be searched in order to determine if there are any assets that depend on the changed asset. In cases where one or more assets depend on a changed asset, the one or more dependent assets may each be invalidated, as well.

In some embodiments, each type of asset (and therefore each associated signature) may be treated with different sensitivity. For example, less sensitive assets (e.g., icons) may have associated signatures that are valid for a longer duration (i.e., the signature may be associated with a longer time window), while more sensitive assets (e.g., app binaries) may have associated signatures that expire much more rapidly. For instance, icons may have associated signatures that are valid for two or three time windows, while app binaries may have associated signatures that expire after one time window. Furthermore, time windows may be different fixed periods of time for each type of asset. For example, time windows associated with icons may be 24 hours, while time windows associated with app binaries may be 4 hours.

Additionally, with respect to the client-side/browser-side cache, there may be immutable assets of which the browser/computer system of the user may be aware (or made aware). For instance, control templates (e.g., button controls, slider controls, and so forth) may be an example of assets that will never change. As such, if a user requests an immutable asset that has been requested previously, the browser/computer system may determine that the asset is immutable and has already been previously downloaded. A browser/computer system may become aware of immutable assets in any number of ways. For example, any generated signature associated with an immutable asset may include a tag that indicates to the browser/computer system that the asset is immutable and therefore, only is to be downloaded upon the first request. Accordingly, a browser/computer system may avoid making subsequent network calls regarding immutable assets and/or avoid re-downloading immutable assets.

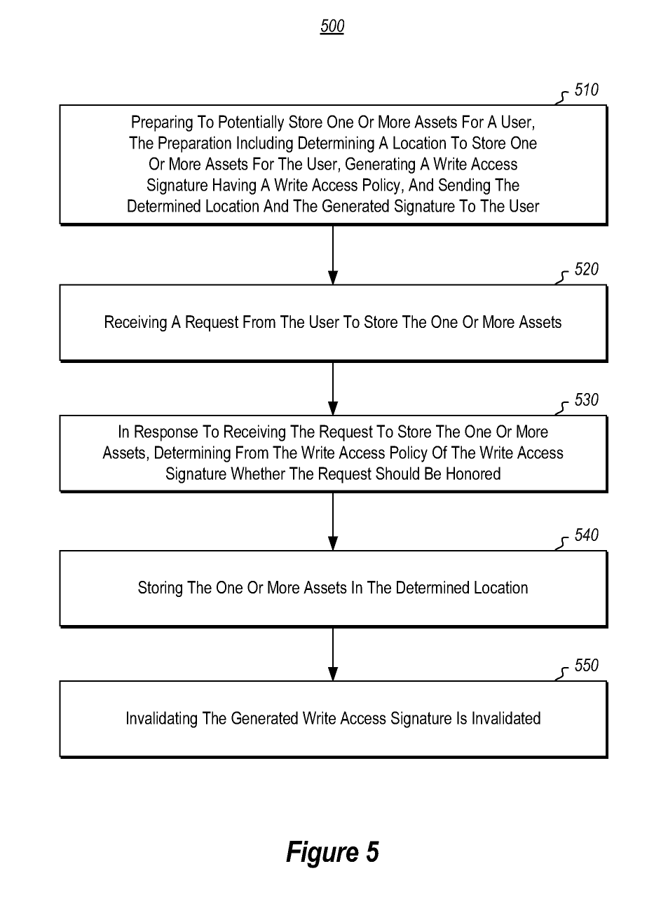

FIG. 5 illustrates a flow chart of an example method 500 for generating signatures to securely store assets in a cloud computer storage service. Method 500 will be described with respect to the components and data of computer architecture 100, as well as environment 200 and environment 300. The method 500 includes preparing to potentially store one or more assets for a user, wherein the preparation may comprise determining a location to store one or more assets for the user, generating a write access signature having a write access policy, and sending the determined location and the generated signature to the user (Act 510). For instance, in the continuing example, a user of MICROSOFT POWERAPPS may request storage space for a created app. In response, the storage service 220 may determine a location to store the assets, generate a write access signature, and send the location and the signature to the user.

The method further includes receiving a request from the user to store the one or more assets (Act 520). The request to store the one or more assets may include at least the one or more assets, the determined location, and the generated write access signature. In the continuing example, the user may use the received location and signature to perform a request to the storage service 220 to save the created app. In response to receiving the request to store the one or more assets, a determination may be made from the write access policy of the write access signature whether the request should be honored (Act 530). Assuming the user has a valid signature, the request is almost certain to be honored.

If the signature is valid, a number of steps may be performed. First, the one or more assets are stored in the determined location (Act 540). Second, the generated write access signature is invalidated (Act 550). Accordingly, in the ongoing example, the user's request to store the user's created app may result in successful storage of the created app. Additionally, the write access signature used to store the app will then be invalidated, such that the user can no longer use that signature for any purpose. As such, the one or more assets are written only once per generated write access signature. However, upon a subsequent user request to access the one or more assets (e.g., the created app), a short-term read access signature having an associated read-only policy may be generated and provided to the user. Accordingly, accessing stored assets (i.e., reads) are to be performed close in time to when short-term read access signatures are requested.

In this way, generating short-term signatures in response to requests to access assets (rather than pre-generating and saving signatures before any request has been made) can greatly reduce the impact of storage key changes in response to both compromised storage keys and planned storage key changes. In particular, storage key changes in response to both compromised storage keys and planned storage key changes may be accomplished much more quickly because existing signatures are not manipulated. Furthermore, the short-term nature of signatures, as described herein, may protect against the malicious use of signatures by users who were previously authorized to access assets, but are no longer authorized. Finally, the use of time windows, as described herein, may improve efficiency in browsers/computer systems by utilizing browser-side/client-side caches to avoid any redundant network calls/downloads relating to unchanged assets.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A computer system comprising:
one or more processors; and
one or more computer-readable storage media having stored thereon computer-executable instructions that are executable by the one or more processors to cause the computer system to generate signatures to securely store assets in a cloud computer storage service, the computer-executable instructions including instructions that are executable to cause the computer system to perform at least the following:
prepare to store one or more assets for a user, the preparation comprising:
determining a location to store one or more assets for the user;
generating a write access signature having a write access policy; and
sending the determined location and the generated signature to the user;
receive a request, from the user, to store the one or more assets, the request to store the one or more assets including at least the one or more assets, the determined location, and the generated write access signature;
in response to receiving the request to store the one or more assets, determine from the write access policy of the write access signature whether the request is to be honored, wherein, upon determining that the request is to be honored, perform the following:
store the one or more assets in the determined location; and
invalidate the generated write access signature, wherein upon a subsequent user request to access the one or more assets, a short-term read access signature having an associated read-only policy is generated and provided to the user, wherein the one or more assets are written only once per generated write access signature.

2. The computer system in accordance with claim 1, wherein one of the one or more assets comprise at least a software application, a video, an image, or an audio file.

3. The computer system in accordance with claim 1, wherein the generated short-term read access signature is valid during one fixed time window of a plurality of time windows.

4. The computer system in accordance with claim 3, wherein when the user requests to access the one or more assets within a particular time window in which the user has already received a short-term read access signature to access the one or more assets, the user receives the same short-term read access signature to access the one or more assets.

5. The computer system in accordance with claim 3, wherein start times for starting a time window are staggered, such that time windows for different users start at different times.

6. The computer system in accordance with claim 3, wherein a time period of the fixed time window is based on a type of asset being read.

7. The computer system in accordance with claim 6, wherein the time period of the fixed time window is longer for assets of a type that change infrequently and shorter for assets of a type that change frequently.

8. The computer system in accordance with claim 1, wherein the determined location, write access signature, and the short-term read access signature each comprise at least a portion of a uniform resource identifier.

9. A method, implemented at a computer system that includes one or more processors, for generating signatures to securely store assets in a cloud computer storage service, comprising:
preparing to store one or more assets for a user, the preparation comprising:
determining a location to store one or more assets for the user;
generating a write-access signature having a write access policy; and
sending the determined location and the generated signature to the user;
receiving a request, from the user, to store the one or more assets, the request to store the one or more assets including at least the one or more assets, the determined location, and the generated write access signature;
in response to receiving the request to store the one or more assets, determining from the write access policy of the write access signature whether the request is to be honored, wherein, upon determining that the request is to be honored, performing the following:
storing the one or more assets in the determined location; and
invalidating the generated write access signature, wherein upon a subsequent user request to access the one or more assets, a short-term read access signature having an associated read-only policy is generated and provided to the user, wherein the one or more assets are written only once per generated write access signature.

10. The method in accordance with claim 9, wherein one of the one or more assets comprise at least a software application, a video, an image, or an audio file.

11. The method in accordance with claim 9, wherein the generated short-term read access signature is valid during one fixed time window of a plurality of time windows.

12. The method in accordance with claim 11, wherein when the user requests to access the one or more assets within a particular time window in which the user has already received a short-term read access signature to access the one or more assets, the user receives the same short-term read access signature to access the one or more assets.

13. The method in accordance with claim 11, wherein start times for starting a time window are staggered, such that time windows for different users start at different times.

14. The method in accordance with claim 11, wherein a time period of the fixed time window is based on a type of asset being read.

15. The method in accordance with claim 14, wherein the time period of the fixed time window is longer for assets of a type that change infrequently and shorter for assets of a type that change frequently.

16. The method in accordance with claim 9, wherein the determined location, write access signature, and the short-term read access signature each comprise at least a portion of a uniform resource identifier.

17. A computer program product comprising one or more hardware storage devices having stored thereon computer-executable instructions that are executable by one or more processors of a computer system to generate signatures to securely store assets in a cloud computer service, the computer-executable instructions including instructions that are executable to cause the computer system to perform at least the following:
prepare to store one or more assets for a user, the preparation comprising:
determining a location to store one or more assets for the user;
generating a write-access signature having a write access policy; and
sending the determined location and the generated signature to the user;
receive a request, from the user, to store the one or more assets, the request to store the one or more assets including at least the one or more assets, the determined location, and the generated write access signature;
in response to receiving the request to store the one or more assets, determine from the write access policy of the write access signature whether the request is to be honored, wherein, upon determining that the request is to be honored, perform the following:
store the one or more assets in the determined location; and
invalidate the generated write access signature, wherein upon a subsequent user request to access the one or more assets, a short-term read access signature having an associated read-only policy is generated and provided to the user, wherein the one or more assets are written only once per generated write access signature.

18. The computer program product in accordance with claim 17, wherein the generated short-term read access signature is valid during one fixed time window of a plurality of time windows.

19. The computer program product in accordance with claim 18, wherein a time period of the fixed time window is based on a type of asset being read.

20. The computer program product in accordance with claim 19, wherein the time period of the fixed time window is longer for assets of a type that change infrequently and shorter for assets of a type that change frequently.
